(19) United States
(12) Patent Application Publication
(10) Pub. No.: US 2020/0238672 A1
(43) Pub. Date: Jul. 30, 2020

(54) BIAXIALLY ORIENTED POROUS FILM HAVING A PARTICLES-CONTAINING POROUS LAYER AND AN INORGANIC COATING

(71) Applicant: Treofan Germany GmbH & Co. KG, Neunkirchen (DE)

(72) Inventors: Bertram SCHMITZ, Saarbrücken (DE); Melanie WISNIEWSKI, Homburg (DE)

(21) Appl. No.: 15/768,873

(22) PCT Filed: Oct. 18, 2016
(86) PCT No.: PCT/EP2016/001726

§ 371 Date: Apr. 17, 2018

(30) Foreign Application Priority Data
Oct. 20, 2015 (DE) 10 2015 013 515.5

(51) Int. Cl. B32B 27/18; B32B 27/32; H01M 2/14; H01M 2/16; C08J 7/04; C08J 5/18

(52) U.S. Cl. CPC B32B 27/18; B32B 27/32; H01M 2/145; H01M 2/166; H01M 2/1686; C08J 7/042; B29C 55/12; C08J 5/18; B32B 2255/10; B32B 2255/20; B32B 2307/72; B32B 2457/10; C08J 7/0427

(57) ABSTRACT

The invention relates to a biaxially oriented, single- or multi-layer porous film, containing a β-nucleating agent and comprising at least one porous layer, which contains at least one propylene polymer and particles, said particles having a melting point of more than 200° C. On the outer surface of the porous layer, said porous film has a coating of inorganic, preferably ceramic particles.

The present invention relates to a biaxially oriented porous film comprising at least one particle-containing porous layer, which is coated on this particle-containing porous layer, and use thereof as a separator, and to a method for producing this film.

Modern appliances require a power source, such as primary batteries or rechargeable batteries, which enable independent use in space. Primary batteries have the disadvantage that they have to be disposed of. Rechargeable batteries (secondary batteries), which can be charged again and again with the aid of charging devices at the mains, are therefore being used increasingly. Conventional nickel-cadmium rechargeable batteries (NiCd rechargeable batteries) for example can achieve a service life of approximately 1000 charging cycles with proper use. Lithium, lithium-ion, lithium-polymer, and alkaline earth batteries are nowadays used increasingly as rechargeable batteries in high-energy or high-performance systems.

Primary batteries and rechargeable batteries always consist of two electrodes, which dip into an electrolyte solution, and a separator, which separates the anode and cathode. The various rechargeable battery types differ by the used electrode material, the electrolyte and the used separator. A battery separator has the task of physically separating the cathode and anode in primary batteries, for example the negative and positive electrodes in rechargeable batteries. The separator must be a barrier which electrically isolates the two electrodes from one another in order to avoid internal short circuits. At the same time, however, the separator must be permeable for ions so that the electrochemical reactions in the cell can take place.

A battery separator must be thin so that the internal resistance is as low as possible and a high packing density and thus energy density in the battery can be attained. Only in this way are good performance data and high capacities possible. In addition it is necessary that the separators absorb the electrolyte and ensure the gas exchange when the cells are full. Whereas, previously, woven fabric was used inter alia, fine pored materials are nowadays used predominantly, such as non-wovens and membranes.

In lithium batteries the occurrence of short circuits is a problem. Under thermal load the battery separator in lithium-ion batteries may melt and therefore lead to a short circuit with devastating consequences. Similar risks are posed when the lithium batteries are mechanically damaged or overloaded by defective electronics of the charging devices.

In order to increase the safety of lithium-ion batteries, shut-down separators (shut-down membranes) were developed in the past. These special separators close their pores in a very short time at a specific temperature, which is far below the melting point or the ignition point of lithium. The catastrophic consequences of a short circuit in lithium batteries are thus largely avoided.

At the same time, however, a high mechanical strength is also desired for the separators and is ensured by materials that have high melting points. For example, polypropylene membranes are advantageous due to their good puncture resistance, but the melting point of polypropylene, at approximately 164° C., is very close to the flash point of lithium (170° C.).

High-energy batteries based on lithium technology are used in applications in which it is crucial to have available the greatest possible quantity of electrical energy in the smallest space. This is the case for example with traction batteries for use in electric vehicles, but also in other mobile applications in which maximum energy density at low weight is required, for example in the aerospace field. Energy densities from 350 to 400 Wh/L or 150 or 200 Wh/kg are currently attained in high-energy batteries. These high energy densities are achieved by the use of special electrode material (for example Li—CoO₂) and the more economical use of housing materials. In Li batteries of the pouch cell type the individual battery units are thus only still separated from one another by a film. Due to this fact, in these cells higher demands are also placed on the separator, since in the event of an internal short circuit and overheating the explosion-like combustion reactions spread to the adjacent cells.

Separators for these applications must be as thin as possible so as to ensure a low specific spatial requirement and must have a large porosity so as to keep the internal resistance small. In the case of overheating or mechanical damage, positive and negative electrode must remain electrically separated under all circumstances so as to prevent further chemical reactions, which lead to fire or explosion of the batteries.

It is known in the prior art to combine polypropylene membranes with further layers that are constructed from materials having a lower melting point, for example from polyethylene. In the case of overheating due to short circuit or other external influences, the polyethylene layer melts and closes the pores of the porous polypropylene layer, whereby the ion flow and thus current flow in the battery is interrupted. However, the polypropylene layer also melts with a further rise in temperature (>160° C.), and an internal short circuit caused by contacting of the anode and cathode and the resultant problems such as spontaneous combustion and explosion can no longer be prevented. In addition, the adhesion of the polyethylene layers to polypropylene layers is problematic, and therefore these layers can be combined only by lamination, or only selected polymers of these two classes can be co-extruded. These separators offer only insufficient safety in high-energy applications. A film of this kind is described in WO 2010048395.

US2011171523 describes a heat-resistant separator which is obtained via a solvent process. Here, in a first step, inorganic particles (chalk, silicates or alumina) are compounded into the raw material (UHMW-PE) together with an oil. This mixture is then extruded through a nozzle to form a preliminary film. The oil is then dissolved out of the preliminary film by means of a solvent in order to create the pores. This film is then drawn to form the separator. The inorganic particles in this separator then ensure the separation of anode and cathode in the battery, even in the event of severe overheating.

This method has the disadvantage that the particles contribute to a weakening of the mechanical properties of the separator and a non-uniform pore structure can be created as a result of agglomerates of the particles.

US2007020525 describes a ceramic separator which is obtained by processing inorganic particles with a polymer-based binder. This separator also ensures that the anode and cathode in the battery remain separated in the event of severe overheating. However, the production method is complex and the mechanical properties of the separator are inadequate.

WO2013083280 describes a biaxially oriented single- or multi-layer porous film comprising an inorganic, preferably ceramic coating. The original porosity of the film is reduced by the ceramic coating only to a small extent. The coated porous film has a Gurley value of <1500 s. According to this teaching, polypropylene separators with a specific surface structure also demonstrate sufficient adhesion compared to water-based inorganic, preferably ceramic coatings, even without the use of primers.

Further membranes are known in the prior art which are combined with temperature-stable layers which also ensure an isolation of the electrodes from one another, even after the melting of the separator. Here, the adhesion of these layers to the substrate is often problematic, and therefore these layers can be combined with the actual membrane only by lamination or coating. Within the scope of the present invention it has been found that the efficacy of ceramic coatings is also dependent on the quality of the coating. For an efficient isolation of the electrodes, a continuous isolation layer formed of the temperature-resistant material, which in turn must not have any defects, gaps or fluctuations in thickness, must be retained after the melting of the membrane. This places a particular requirement on the membrane to be coated in respect of the thickness uniformity and surface properties.

The separator materials with temperature-stable protective layer also have to be as thin as possible in order to ensure a low spatial requirement in order to keep the internal resistance small and have a large porosity. These properties are negatively influenced by the coating, since the coating leads to an increase in the thickness of the membrane and to a reduced porosity and compromises the surface structure of the film.

In principle, there is also a demand for higher process speeds with regard to the production of the separator films. Due to the fragile network structure, higher process speeds are particularly critical with regard to the production of porous films, since they are accompanied by tears and quality defects, such that the process as a whole is less economical.

Polyolefin separators can nowadays be produced by different methods: filling methods; cold drawing, extraction methods and β-crystallite methods. These methods differ in principle by the various mechanisms by which the pores are produced.

For example, porous films can be produced by the addition of very high amounts of fillers. The pores are created during drawing by the incompatibility of the fillers with the polymer matrix. The large amounts of fillers of up to 40% by weight, which are necessary in order to attain high porosities, significantly compromise the mechanical strength, however, in spite of high drawing, and therefore these products cannot be used as separators in a high-energy cell.

In what is known as the extraction method the pores are produced in principle by dissolving out a component from the polymer matrix by suitable solvent. Here, a wide range of variants have been developed, which differ by the type of additives and the suitable solvents. Both organic and inorganic additives can be extracted. This extraction can be performed as the last method step during production of the film or can be combined with a subsequent drawing. What is disadvantageous in this case is the ecologically and economically dubious extraction step.

A method that is older, but that is successful in practice is based on a drawing of the polymer matrix at very low temperatures (cold drawing). To this end, the film is first extruded and is then annealed for a few hours in order to increase the crystalline proportion. In the next method step the cold drawing is performed in the longitudinal direction at very low temperatures in order to produce a large number of defects in the form of very small microcracks. This pre-drawn film with defects is then again drawn in the same direction at elevated temperatures with higher factors, wherein the defects are enlarged to form pores, which form a network-like structure. These films combine high porosities and good mechanical strength in the direction of their drawing, generally the longitudinal direction. The mechanical strength in the transverse direction however remains inadequate, whereby the puncture resistance is poor and there is a high tendency for splitting in the longitudinal direction. On the whole, the method is cost-intensive.

A further known method for producing porous films is based on the admixing of β-nucleating agents to polypropylene. As a result of the β-nucleating agent, the polypropylene forms what are known as β-crystallites in high concentrations as the melt cools. With the subsequent longitudinal drawing, the β-phase converts into the alpha-modification of the polypropylene. Since these different crystal forms differ in terms of density, many microscopic defects are also initially produced here and are torn open by the drawing to form pores. The films produced by this method have high porosities and good mechanical strength in the longitudinal and transverse direction and a very good cost effectiveness. These films will also be referred to hereinafter as 1-porous films. To improve porosity, a higher orientation in the longitudinal direction can be introduced prior to transverse drawing.

German patent application number 10 2014 005 890.5 describes a β-nucleated porous film modified by the addition of nanoscale inorganic particles. The content of particles should be so high that in the case of temperature increases above the melting point of the polypropylene a layer of inorganic particles remains and separates the electrodes. Even if the polypropylene melts, the contact between anode and cathode should thus be effectively prevented. However, particle contents of up to 60% by weight are necessary for this purpose. These high particle amounts are problematic, since the process reliability during production is compromised. In order to counteract this negative effect, the particles should not be greater than 1 μm. As a result of these constraints, relatively thin layers formed for example of TiO₂ are created as the polypropylene melts and should by further improved in respect of reliability and stability.

The object of the present invention was to provide a film which, when used as a separator, ensures the isolation of the electrodes even at very high temperatures or when the battery has sustained mechanical damage. This isolating function must also be retained even when the temperatures within the battery lie above the melting point of the polymers of the separator. Nevertheless it should be possible to produce this film efficiently and inexpensively.

Furthermore, it should be possible to produce the porous films with a high process speed and a good fault-free extent. This means that there should be only too few or even no tears during the production of the film, even at increased process speeds. A permanent concern is the improvement of the porosity, wherein in particular low Gurley values are to be attained by few closed regions on the film surface. A further object is to provide a porous film of low thickness, wherein, even with a small film thickness, production at high process speed should be possible and low Gurley values should be obtained by the film.

A further object of the present invention was therefore to provide a porous film having an improved Gurley value, i.e. good permeability.

A further object of the present invention was to enable a high process speed with regard to the production of porous films with low Gurley value.

These and further objects are achieved by a biaxially oriented, single- or multi-layer porous film, containing at least one β-nucleating agent and comprising at least one porous layer, wherein this porous layer contains at least one propylene polymer and particles, said particles having a melting point of more than 200° C. and said film having, on the outer surface of the porous layer, a coating formed of inorganic particles.

Surprisingly, the combination of particle-containing porous film and coating formed of inorganic particles significantly improves the separator with regard to its reliability under high temperature loads. The addition of the particles having a high melting point in the porous film in itself offers good protection against internal short-circuits in the case of use as separator in highly reactive primary batteries and rechargeable batteries. Together with the particles of the applied coating, a separation layer is formed as the polypropylene melts, which separation layer provides excellent isolation of the electrodes and ensures excellent long-term stability and additionally prevents the formation of dendrites.

Since, by the addition of particles having a high melting point in the porous layer, the Gurley value of the porous films is reduced, this film is a particularly advantageous base film for the subsequent coating. In addition, an increase of the process speed is possible by the addition of the particles. The number of tears is reduced, even at increased process speeds.

Even low contents of β-crystalline polypropylene in the base film are sufficient to produce films having very low Gurley values. The addition of the particles in the porous film therefore makes it possible to reduce the content of β-nucleating agents in the porous film.

Particles in the sense of the present invention are particles having a melting point of more than 200° C. These particles can be present as individual particles or can form agglomerates, which are constructed from a plurality of individual particles.

The base film in the sense of the present invention is the biaxially oriented single- or multi-layer porous film, which does not have a coating.

The porous films can be constructed in one or more layers and comprise at least one porous layer which is constructed from propylene polymers, preferably propylene homopolymers and/or propylene block copolymers, and generally contains at least one β-nucleating agent and also particles having a high melting point. In a further embodiment, polyethylene can additionally be contained in the porous layer. Other polyolefins, i.e. other than the aforesaid propylene polymers or ethylene polymers, can optionally additionally be contained in small amounts, provided they do not adversely affect the porosity and other key parameters. Furthermore, the porous layer optionally additionally contains conventional additives, for example stabilisers and/or neutralising agents, in each case in effective amounts.

Suitable propylene homopolymers for the porous layer contain 98 to 100% by weight, preferably 99 to 100% by weight, of propylene units and have a melting point (DSC) of 150° C. or higher, preferably 155 to 170° C., and generally a melt flow index from 0.5 to 10 g/10 min, preferably 2 to 8 g/10 min, at 230° C. and a force of 2.16 kg (DIN 53735). Isotactic propylene homopolymers with an n-heptane-soluble component of less than 15% by weight, preferably 1 to 10% by weight, constitute preferred propylene homopolymers for the layer. Isotactic propylene homopolymers with a high chain isotacticity of at least 96%, preferably 97-99% (¹³C-NMR; triad method), can also be used advantageously. These raw materials are known as HIPP polymers (high isotactic polypropylenes) or HCPPs (high crystalline polypropylenes) in the prior art and are characterised by a high stereoregularity of the polymer chains, higher crystallinity and a higher melting point (compared with propylene polymers with a ¹³C-NMR isotacticity from 90 to <96%, which can be used equally).

Propylene block copolymers have a melting point of more than 140 to 170° C., preferably from 145 to 165° C., in particular 150 to 160° C., and a melting range that starts at above 120° C., preferably in a range of 125-160° C. The comonomer content, preferably ethylene content, for example is between 1 and 20% by weight, preferably 1 and 10% by weight. The melt flow index of the propylene block copolymers generally lies in a range from 1 to 20 g/10 min, preferably 1 to 10 g/10 min.

In a further embodiment the porous layer may additionally contain polyethylenes, for example HDPE or MDPE. These polyethylenes such as HDPE and MDPE are generally incompatible with the polypropylene and when mixed with polypropyiene form a separate phase. The presence of a separate phase is demonstrated for example in a DSC measurement by a separate melt peak in the region of the melting point of the polyethylene, generally in a range of 115-145° C., preferably 120-140° C. The HDPE generally has an MFI (50 N/190° C.) of greater than 0.1 to 50 g/10 min, preferably 0.6 to 20 q/10 min, measured in accordance with DIN 53 735, and a viscosity number, measured in accordance with DIN 53 728, part 4, or ISO 1191, in the range of 100 to 450 cm3/g, preferably 120 to 280 cm3/g. The crystallinity is 35 to 80%, preferably 50 to 80%. The density, measured at 23° C. in accordance with DIN 53 479, method A, or ISO 1183, lies in the range from >0.94 to 0.97 g/cm³. The melting point, measured with DSC (maximum of the melt curve, heating rate 10K/lmin), is between 120 and 145° C., preferably 125-140° C. Suitable MDPE generally has an MFI (50 N/190° C.) of greater than 0.1 to 50 g/10 min, preferably 0.6 to 20 g/10 min, measured in accordance with DIN 53 735. The density, measured at 23° C. in accordance with DIN 53 479, method A, or ISO 1183, lies in the range from 0.925 to 0.94 g/cm³. The melting point, measured with DSC (maximum of the melt curve, heating rate 10K/min), lies between 115 and 130° C., preferably 120-125° C.

Preferred polyethylenes have a narrow melting range. This means that, in a DSC of the polyethylene, the start of the melting range and the end of the melting range are distanced from one another at most by 10 K, preferably 3 to 8 K. Here, the start of the melting range is constituted by the extrapolated onset and the end of the melting range is accordingly constituted by the extrapolated end of the melt curve (heating rate 10 K/min).

The parameters “melting point” and “melting range” are determined by means of DSC measurement and are ascertained form the DSC curve, as described in the measurement methods.

Where appropriate, the porous layer may additionally contain other polyolefins, different from polypropylene and polyethylene, provided they do not negatively influence the properties, in particular the porosity and the mechanical strengths. For example, other polyolefins are statistical copolymers of ethylene and propylene with an ethylene content of 20% by weight or below, statistical copolymers of propylene with C₄-C₈ olefins with an olefin content of 20% by weight or below, terpolymers of propylene, ethylene and butylene with an ethylene content of 10% by weight or below and with a butylene content of 15% by weight or below.

In a preferred embodiment, the porous layer is formed only from propylene homopolymer and/or propylene block copolymer and β-nucleating agent and the particles with a melting point above 200° C., and where appropriate stabilisers and neutralising agent.

In a further possible embodiment the porous layer is constructed only from propylene homopolymer and/or propylene bock copolymer and particles, and optionally stabiliser and neutralising agent, and the β-nucleating agent is contained in a further porous layer. In principle, however, it is preferable to add the β-nucleating agent to the particle-containing layer. Thus, in one-layer embodiments which are constructed only from the porous layer, the β-nucleating agent is always contained in this porous layer,

In principle, all known additives that promote the formation of β-crystals of the polypropylene as a polypropylene melt cools are suitable as β-nucleating agents for the porous layer. Such n-nucleating agents, and also their efficacy in a polypropylene matrix, are known per se in the prior art and will be described in detail hereinafter.

Various crystalline phases of polypropylene are known. When a melt is cooled, the α-crystalline polypropylene is usually formed predominantly, of which the melting point lies in the range of 155-170° C., preferably 158-162° C. By means of a specific temperature control, a low proportion of β-crystalline phase can be produced when cooling the melt, which phase has a much lower melting point compared with the monoclinic α-modification, with values of 145-152° C., preferably 148-150° C. In the prior art, additives are known that lead to an increased proportion of the 3-modification when cooling the polypropylene, for example γ-quinacridone, dihydroquinacridine or calcium salts of phthalic acid.

For the purposes of the present invention, highly active β-nucleating agents are preferably used in the porous film, which, when cooling a propylene homopolymer melt, produce a β-proportion of 40-95%, preferably of 50-100% (DSC). The β-proportion is determined from the DSC of the cooled propylene homopolymer melt. By way of example, a two-component 0-nucleating system formed of calcium carbonate and organic dicarboxylic acids is preferred and is described in DE 3610644, to which reference is hereby expressly made. Calcium salts of dicarboxylic acids, such as calcium pimelate or calcium suberate, are particularly advantageous, as described in DE 4420989, to which reference is also expressly made. The dicarboxamides described in EP-0557721, in particular N,N-dicyclohexyl-2,6-naphthalene dicarboxamides, are suitable β-nucleating agents.

In addition to the β-nucleating agents, the observance of a certain temperature range and dwell times at these temperatures when cooling the undrawn melt film is key in order to attain a high proportion of β-crystalline polypropylene. The melt film is preferably cooled at a temperature from 60 to 140° C., in particular 80 to 130° C., for example 85 to 128° C. Slow cooling also promotes the growth of the β-crystallites, and therefore the discharge speed, that is to say the speed at which the melt film passes over the first chilling roll, should be slow so that the necessary dwell times at the selected temperatures are sufficiently long. Since increased process speeds are possible due to the addition of the particles, the discharge speeds can vary in principle within a relatively wide range for porous films. The discharge speed is generally 1 to 100 m/min, preferably 1.2 to 60 m/min, in particular 1.3 to 40 m/min, and particularly preferably 1.5 to 25 m/min or 1 to 20 m/min. The dwell time could be extended or reduced accordingly and for example can be 10 to 300 s; preferably 20 to 200 s.

The porous layer generally contains 40 to <98% by weight, preferably 40 to 90% by weight, of propylene homopolymers and/or propylene block copolymer and generally 0.001 to 5% by weight, preferably 50-10,000 ppm, of at least one β-nucleating agent and 2 to <70% by weight of particles, in relation to the weight of the porous layer. For embodiments without β-nucleating agent in the porous layer, the proportion of propylene homopolymers and/or propylene block copolymers is correspondingly high. For the case that polyethylenes and/or further polyolefins are additionally contained in the layer, the proportion of the propylene homopolymers or of the block copolymer is reduced accordingly.

In one embodiment which additionally contains polyethylene in the porous layer, the proportion of polyethylene in the porous layer is generally 5 to 40% by weight, preferably 8 to 30% by weight, in relation to the porous layer. The proportion of propylene homopolymers or block copolymers is reduced accordingly.

Additional polyolefins different from polypropylene and polyethylene are contained in the porous layer in an amount of 0 to <10% by weight, preferably 0 to 5% by weight, in particular 0.5 to 2% by weight, when these are additionally provided. Similarly, it is true that said propylene homopolymer or propylene block copolymer proportion is reduced when higher amounts of up to 5% by weight of nucleating agent are used.

In addition, the porous layer can contain conventional stabilisers and neutralising agents, and optionally further additives, in the conventional small amounts of less than 2% by weight.

In a preferred embodiment, the porous layer contains as polymers a mixture of propylene homopolymer and propylene block copolymer. The porous layer in this embodiment generally contains 10 to 93% by weight, preferably 20 to 90% by weight, of propylene homopolymers and 5 to 88% by weight, preferably 10 to 60% by weight, of propylene block copolymers, and 0.001 to 5% by weight, preferably 50 to 10,000 ppm, of at least one β-nucleating agent, and 2 to 60% by weight of particles, in relation to the weight of the porous layer, and optionally the aforementioned additives, such as stabilisers and neutralising agents.

Particularly preferred embodiments of the porous film according to the invention contain 50 to 10,000 ppm, preferably 50 to 5,000 ppm, in particular 50 to 2,000 ppm, of calcium pimelate or calcium suberate as β-nucleating agent in the porous layer.

The porous film may be formed in one or more layers. The thickness of the film generally lies in a range from 10 to 100 μm, preferably 15 to 60 μm, for example 15 to 40 μm.

The porous film can be provided on its surface with a corona, flame or plasma treatment, for example in order to improve the filling with electrolyte and/or to improve the adhesion properties in relation to the subsequent coating. By the addition of the particles, porous films having a thickness of less than 25 μm can also be produced with an increased process speed and/or few tears.

In a simple embodiment the film is a single-layer film and then consists only of the above-described particle-containing porous layer. In this case the proportion of particles is preferably 5 to 50% by weight, in particular 10-40% by weight, in relation to the weight of the film.

In a further embodiment the porous film is a multi-layer film and comprises, in addition to the above-described particle-containing porous layer, a further porous layer, said porous layers differing from one another in respect of the composition.

In this multi-layer embodiment, the particle-containing porous layer is an outer cover layer I on a further porous layer II. In this case the proportion of particles in the cover layer I is preferably 10 to 70% by weight, in particular 15 to 60% by weight, in relation to the weight of the cover layer I. These films then comprise at least the particle-containing porous cover layer I and a further porous layer II.

In a further embodiment particle-containing porous layers are applied on both sides as outer cover layers Ia and Ib to a porous layer II. In this case the proportion of particles in the two cover layers Ia and Ib is, in each case independently of one another, preferably 10 to 70% by weight, in particular 15 to 60% by weight, in relation to the weight of the cover layer in question.

A common feature of these multi-layer embodiments is that all layers of the film are porous, and therefore the films themselves resulting from these layered constructions, are also porous films. In the multi-layer embodiment the respective compositions of the particle-containing porous layer(s) I or Ia and Ib and of the porous layers II are different.

The further porous layer(s) II are in principle constructed similarly to the above-described particle-containing porous layer, wherein however no particles are contained. The proportion of propylene polymers is increased accordingly in these porous layers II. The further porous layer(s) II is/are thus composed as follows.

The further porous layer II generally contains 45 to <100% by weight, preferably 50 to 95% by weight, propylene homopolymers and/or propylene block copolymer and 0.001 to 5% by weight, preferably 50-10,000 ppm of at least one R-nucleating agent, in relation to the weight of the porous layer. Should polyethylenes or other polyolefins be contained additionally in the layer II, the proportion of the propylene homopolymers or of the block copolymers is reduced accordingly. Generally, the amount of optional additional polyethylenes is 5 to <50% by weight, preferably 10 to 40% by weight, and the proportion of the other polymers in the layer II is 0 to <10% by weight, preferably 0 to 5% by weight, in particular 0.5 to 2% by weight, when these are additionally contained. Similarly, said propylene homopolymer or propylene block copolymer proportion is reduced if higher amounts of up to 5% by weight of nucleating agent are used. In addition, the layer II can also contain conventional stabilisers and neutralising agents, and optionally further additives, in the conventional low amounts of less than 2% by weight.

The density of the uncoated porous film or of the porous particle-containing layer lies generally in a range of from 0.1 to 0.6 g/cm³, preferably 0.2 to 0.5 g/cm³.

The particle-containing porous films are characterised by the following further properties, wherein these amounts relate to the uncoated porous base film.

The maximum pore size measured (by means of bubble point) of the porous film according to the invention is <350 nm and lies preferably in the range of from 20 to 350 nm, in particular from 40 to 300 nm, particularly preferably 40 to 200 nm. The mean pore diameter should generally lie in the range of from 20 to 150 nm, preferably in the range of from 30 to 100 nm, in particular in the range of from 30 to 80 rm. The porosity of the porous film lies generally in a range of from 30 to 80%, preferably 50 to 70%. The film according to the invention is preferably characterised by a Gurley value of less than 500 s/100 cm³, in particular of less than 200 s/100 cm, in particular from 10 to 150 s/100 cm³.

The addition of the particles contributes to the separation of the electrodes at high temperatures. Together with the particles of the coating, a particularly effective separation layer is constructed when the temperature within the battery exceeds the melting point of the polymers. This protective effect functions both in the case of separators whose pores close in the event of a temperature increase and in the case of separators without this ‘shut-down’ function (increase in the Gurley value of the porous film at high temperatures). Separators formed of the coated porous film according to the invention thus offer improved protection against battery fires or even explosions as a result of short circuits, mechanical damage or overheating.

The added particles also have an advantageous effect on the gas permeability of the films. Due to the addition of the particles, the Gurley value is reduced compared to a film having a similar composition without particles, although the particles themselves generally do not develop a β-nucleating effect. In addition, it is known in the prior art that particles having a particle size of less than 1 μm in a polypropylene matrix also do not have a vacuole- or pore-forming effect.

The particles of the porous film having a melting point of greater than 200° C. comprise inorganic and organic particles. In the sense of the present invention particles are not substances which lead to a higher proportion of β-crystalline polypropylene. They therefore are not 1-nucleating agents. Particles in the sense of the present invention are non-vacuole-initiating particles. The particles used in accordance with the invention are preferably approximately spherical particles or spherical particles.

Vacuole-initiating particles are known in the prior art and produce vacuoles in a polypropylene film when said film is drawn. Vacuoles are closed cavities and also reduce the density of the film compared to the theoretical density of the starting materials. By contrast, porous films or layers have a network of interconnected pores. Pores therefore are not closed cavities. Both porous films and vacuole-containing films have a density of less than 0.9 g/cm³. The density of vacuole-containing biaxially drawn polypropylene films is generally 0.5 to <0.85 g/cm³. Generally, in the case of particles, a particle size of more than 1 μm is necessary in order to act as vacuole-initiating particles in a polypropylene matrix. It can be checked on the basis of a reference film formed of propylene homopolymer whether particles are vacuole-initiating particles or non-vacuole-initiating particles.

To this end, a biaxially drawn film formed of propylene homopolymer and 8% by weight of the particles to be checked is produced by means of a conventional boPP method. Here, conventional drawing conditions are applied (longitudinal drawing factor 5 at drawing temperature 110° C. and transverse drawing factor 9 at a transverse drawing temperature of 140° C.). The density of the film is then ascertained. If the density of the film is ≤0.85 g/cm³ the particles are vacuole-initiating particles. If the density of the film is greater than 0.85 g/cm³, preferably greater than 0.88 g/cm³, in particular greater than 0.9 g/cm³, the particles are non-vacuole-initiating particles in the sense of the present invention.

Inorganic particles in the sense of the present invention are all natural or synthetic minerals, provided they have the above-mentioned melting point of greater than 200° C. Inorganic particles in the sense of the present invention comprise materials based on silicate compounds, oxidic raw materials, for example metal oxides, and non-oxidic and non-metallic raw materials.

Inorganic particles are for example alumina, aluminium sulphate, barium sulphate, calcium carbonate, magnesium carbonate, silicates such as aluminium silicate (kaolin clay) and magnesium silicate (talc) and silicon dioxide, with titanium dioxide, alumina and silicon dioxide being preferred.

Suitable silicates include materials that have an SiO4 tetrahedron, for example sheet or framework silicates. Suitable oxidic raw materials, in particular metal oxides, for example include aluminas, zirconium oxides, barium titanate, lead zirconate titanate, ferrites and zinc oxide. Suitable non-oxidic and non-metallic raw materials for example include silicon carbide, silicon nitride, aluminium nitride, boron nitride, titanium boride and molybdenum silicide.

Oxides of the metals Al, Zr, Si, Sn, Ti and/or Y are preferred. The production of such particles is described in detail in DE-OA-10208277, for example.

In particular, particles based on oxides of silicon with the molecular formula SiO2, and mixed oxides with the molecular formula AlNaSiO2 and oxides of titanium with the molecular formula TiO2 are preferred, wherein these can be present in crystalline, amorphous or mixed form.

The preferred titanium dioxide particles generally consist to an extent of at least 95% by weight of rutile and are preferably used with a coating formed of inorganic oxides, as is used conventionally as a coating for TiO₂ white pigment in papers or coating agents for improving light fastness. TiO₂ particles with a coating are described for example in EPA-0 078 633 and EPA-0 044 515.

The coating optionally also contains organic compounds with polar and nonpolar groups. Preferred organic compounds are alkanols and anionic and cationic surfactants with 8 to 30 carbon atoms in the alkyl group, in particular fatty acids and primary n-alkanols with 12 to 24 carbon atoms, and polydiorganosiloxanes and/or polyorganohydrogen siloxanes, such as polydimethylsiloxane and polymethyl hydrogen siloxane.

The coating on the TiO₂ particles usually consists of 1 to 12 g, in particular 2 to 6 g, of inorganic oxides, optionally and additionally 0.5 to 3 g, in particular 0.7 to 1.5 g, of organic compounds, in each case in relation to 100 g of TiO₂ particles. It has proven to be particularly advantageous if the TiO₂ particles are coated with Al₂O₃ or with Al₂O₃ and polydimethylsiloxane.

Further suitable inorganic oxides are the oxides of aluminium, silicon, zinc, or magnesium, or mixtures of two or more of these compounds. They are precipitated in the aqueous suspension from water-soluble compounds, for example alkali, in particular sodium aluminate, aluminium hydroxide, aluminium sulphate, aluminium nitrate, sodium silicate or silicic acid.

Organic particles are based on polymers which are incompatible with the propylene polymers of the porous particle-containing layer. Organic particles are preferably based on copolymers of cyclic olefins (COC) as described in EP-A-O 623 463, polyesters, polystyrenes, polyamides, halogenated organic polymers, wherein polyesters such as polybutylene terephthalates and cycloolefin copolymers are preferred. The organic particles should be incompatible with the polypropylenes. In the sense of the present invention, incompatible means that the material or the polymer is present in the film as a separate particle.

The particles have a melting point of at least 200° C., in particular at least 250° C., very particularly preferably at least 300° C. In addition, the aforesaid particles also generally should not experience any decomposition at the aforesaid temperatures. The stated amounts can be determined by means of known methods, for example DSC (differential scanning calorimetry) or TG (thermogravimetry).

The preferred inorganic particles generally have melting points in the range of from 500 to 4000° C., preferably 700 to 3000° C., in particular 800 to 2500° C. The melting point of TiO2 is for example approximately 1850° C.

Organic particles that are used also have a melting point of greater than 200° C. and should not experience any decomposition in particular at the specified temperatures.

It is advantageous that the particles have a mean particle size of at most 1 μm, since larger particles lead to increased tears during the production of the film. Mean particle sizes of from 10 to 800 nm, in particular from 50 to 500 nm, are preferred. The particles should be present in an agglomerate-free fine distribution in the porous layer to the greatest possible extent, since otherwise even just a few agglomerates increase the frequency of tears from a certain critical size, for example >1 μm, in particular from 1 to 3 μm, even in small numbers. The mean particle size thus contributes to the fact that the film does not contain any agglomerates or contains less than one agglomerate with a particle size of >1 μm, wherein this is determined on a film sample (uncoated) of 10 mm² by means of SEM images. Similarly, for individual non-agglomerated particles, it is also true that these have a size (absolute) of less than 1 μm. Accordingly, said film sample of 10 mm² also demonstrates less than one non-agglomerated particle or no non-agglomerated particles with a particle size of more than 1 μm. By choosing particles that have little or even no tendency to agglomerate and that have a small mean particle size and that have a particle size distribution such that no particles or only individual particles having a particle size of >1 μm are present, porous films can be produced and the wide range of different advantages of the invention can be provided.

In order to ensure few agglomerates, it is preferred in principle to incorporate the particles via a batch or a premix at the time of film production. The batches or premixes contain propylene polymers and particles, and optionally additionally conventional additives. At the time of production of the batches, a twin-screw extruder is preferably used in order to improve dispersion of the particles in the polymer and/or mixing is performed with a high shear rate. The addition of surface-active substances also contributes to a uniform distribution of the particles in the polymer. It is also favourable to provide the particles themselves with a coating in a previous step. These measures are recommended in particular with use of inorganic particles. As a result of these and other measures known from the prior art, it can be ensured that agglomerate-free batches or premixes are used.

The method for producing the particle-containing porous film will be described hereinafter. The process speed for producing the particle-containing porous film can vary within a wide range. The addition of particles enables quicker process speeds, which are not accompanied by poorer gas permeability or a higher number of tears. The speed of the process lies generally between 3 and 400 m/min, preferably between 5 and 250 m/min, in particular between 6 and 150 m/min or between 6.5 and 100 m/min.

In accordance with this method, the porous film is produced by the flat-film extrusion or coextrusion method, which are known per se. Within the scope of this method, an approach is adopted such that the mixture of polymers (propylene homopolymer and/or propylene block copolymer) and generally β-nucleating agent and particles and optionally further polymers is mixed with the respective layer, melted in an extruder and, optionally jointly and simultaneously, extruded or coextruded through a flat-film die onto a take-off roll, on which the single-layer or multilayer melt film solidifies and cools, thus forming the 5-crystallites. The cooling temperatures and cooling times are selected such that a maximum proportion of β-crystalline polypropylene is produced in the porous film of the preliminary film. Generally, this temperature of the take-off roll or of the take-off rolls is 60 to 140° C., preferably 80 to 130° C. The dwell time at this temperature may vary and should be at least 2 to 120 s, preferably 30 to 60 s. The preliminary film thus obtained generally contains in the porous layer a proportion of β-crystallites (1^{st} heating) of 30-70%, preferably 50-90%.

This preliminary film with a high proportion of β-crystalline polypropylene in the porous layer is then biaxially drawn in such a way that, during the drawing, the 5-crystallites are converted into α-crystalline polypropylene and a network-like porous structure is formed. The biaxial drawing (orientation) is generally performed successively, wherein drawing is preferably first performed longitudinally (in machine direction) and then transversely (perpendicularly to the machine direction).

For the drawing in longitudinal direction, the preliminary film is first guided over one or more heating rolls, which heat the film to the suitable temperature. This temperature is generally less than 140° C., preferably 70 to 120° C. The longitudinal drawing is then performed generally with the aid of two rolls running at different speeds in accordance with the sought draw ratio. The longitudinal draw ratio lies here in a range from 2:1 to 6:1, preferably 3:1 to 5:1.

Following this longitudinal drawing, the film is first cooled again via rolls that are temperature-controlled accordingly. Heating is then performed again in what are known as the heating fields to a transverse drawing temperature, which generally lies at a temperature of 120-145° C. The transverse drawing is then performed with the aid of an appropriate clip frame, wherein the transverse drawing ratio lies in a range from 2:1 to 9:1, preferably 3:1 to 8:1.

Optionally, after the last drawing, generally the transverse drawing, one or both surfaces of the film can be corona-, plasma- or flame-treated in accordance with one of the known methods, such that the filling with electrolyte and/or the adhesion of the subsequent coating are/is promoted.

Lastly, a thermofixing (heat treatment) is optionally performed, in which the film is held for approximately 5 to 500 s, for example 10 to 300 s, at a temperature of 110 to 150° C., preferably at 125 to 145° C., for example via rolls or an air heater box. The film is optionally conveyed in a converging manner immediately before or during the thermofixing, wherein the convergence is preferably 5-25%, in particular 8 to 20%. The term convergence is understood to mean a slight bringing together of the transverse drawing frame, such that the maximum width of the frame that is given at the end of the transverse drawing process is greater than the width at the end of the thermofixing. Of course, the same is true for the width of the film web. The degree to which the transverse drawing frame is brought together is specified as convergence, which is calculated from the maximum width of the transverse drawing frame Bₘₐₓ and the end film width B_{film} in accordance with the following formula:

Convergence [%]=100×(Bₘₐₓ−B_{film})/Bₘₐₓ

The film is then rolled up in the usual manner using a winding device.

In known sequential methods, in which longitudinal and transverse drawing are performed successively in one process, it is not only the transverse drawing speed that is dependent on the process speed. The discharge speed and the cooling rate also vary with the process speed. These parameters therefore cannot be selected independently of one another. It follows that, under otherwise identical conditions, in the case of a quicker process speed, not only are the transverse drawing speed and the discharge speed increased, but at the same time the cooling time of the preliminary film is reduced. This may constitute an additional problem, although this is not necessarily the case.

The above-mentioned process speeds are to be understood in each case to mean the speed, for example in m/min, at which the film is conveyed/wound during the final winding. The method conditions during the method according to the invention for producing the porous films differ from the method conditions that are usually observed with the production of a biaxially oriented film. In order to attain a high porosity and permeability, both the cooling conditions during the solidification of the preliminary film and the temperatures and the factors during the drawing are critical. Firstly, a high proportion of R-crystallites in the preliminary film has to be attained by correspondingly slow and moderate cooling, that is to say at comparatively high temperatures. During the subsequent longitudinal drawing, the R-crystals are converted into the alpha modification, whereby imperfections are produced in the form of microcracks. So that these imperfections are produced in sufficient number and in the correct form, the longitudinal drawing has to be performed at comparatively low temperatures. During the transverse drawing, these imperfections are torn open to form pores, such that the characteristic network structure of these porous films is produced.

These temperatures, which are low compared with conventional BOPP processes, in particular during the longitudinal drawing, require high drawing forces, which on the one hand introduce a high orientation into the polymer matrix and on the other hand increase the risk of tearing. The higher the desired porosity, the lower must the temperatures during the drawing be selected and the higher must be the drawing factors. The process is therefore in principle more critical, the higher are to be the porosity and permeability of the film. The porosity therefore cannot be increased arbitrarily via higher drawing factors or a lowering of the drawing temperature. In particular, the lowered longitudinal drawing temperature leads to a heavily impaired conveying reliability of the film and to an unwanted increase of the tendency for splitting. The porosity therefore can no longer be improved further by lower longitudinal drawing temperatures for example below 70° C.

Further, it is possible to additionally influence the porosity and permeability of the film via the drawing speed during the transverse drawing. A slow transverse drawing increases the porosity and permeability further, without leading to increased tearing or other disruptions during the production process. The slow process speed, however, increases the production costs significantly.

The addition of the particles assists the formation of the porous structure advantageously, although the particles alone do not result in the formation of pores. It would appear that the particles in conjunction with a certain content of β-crystalline polypropylene assist the creation of the pore structure in a favourable manner, such that, with a given β-crystaliite proportion in the preliminary film, much higher porosities are retained by the addition of the particles and cannot be demonstrated without the corresponding addition of particles with a given β-proportion. The particles interact with the β-crystallites synergistically, such that a reduction of the β-proportion in the film does not lead to lower Gurley values. The improved gas permeability can also be used positively by way of an increase of the process speed, since the particles contribute to an improvement of the Gurley value, i.e. the particle-containing films according to the invention can be produced more quickly, i.e. more economically, with the same Gurley values.

It has surprisingly been found that the number of tears does not increase significantly in spite of the increase in the process speed when the film contains the particles according to the invention. Or, by means of the method, a film having a particularly high permeability can be produced.

The biaxially oriented single- or multi-layer particle-containing porous film is provided in accordance with the invention, at least on the surface of the porous particle-containing layer, with an inorganic, preferably ceramic coating. This inorganic coating is electrically insulating, or is formed from particles that are electrically insulating.

The inorganic, preferably ceramic coating according to the invention comprises inorganic particles, which are also understood to include ceramic particles. The particle size expressed as D50 value lies in the range between 0.005 and 10 μm, preferably in the range 0.01 to 5 μm. The exact particle size is selected in accordance with the thickness of the inorganic, preferably ceramic coating. Here, it has been found that the D50 value should not be greater than 50% of the thickness of the inorganic, preferably ceramic coating, preferably should not be greater than 33% of the thickness of the inorganic, preferably ceramic coating, and in particular should not be greater than 25% of the thickness of the inorganic, preferably ceramic coating. In a particularly preferred embodiment of the invention, the D90 value is no greater than 50% of the thickness of the inorganic, preferably ceramic coating, preferably no greater than 33% of the thickness of the inorganic, preferably ceramic coating, and in particular no greater than 25% of the thickness of the inorganic, preferably ceramic coating.

In the context of the present invention, inorganic, preferably ceramic particles are understood to mean all natural or synthetic minerals, provided they have the aforementioned particle sizes. The inorganic, preferably ceramic particles are not subject to any limitation in terms of the particle geometry, however spherical particles are preferred. Furthermore, the inorganic, preferably ceramic particles may be present in crystalline form, partly crystalline form (minimum 30% crystallinity) or non-crystalline form.

In the context of the present invention, ceramic particles are understood to mean materials based on silicate raw materials, oxidic raw materials, in particular metal oxides, and/or non-oxidic and non-metallic raw materials.

Suitable silicate raw materials include materials that have an SiO4 tetrahedron, for example sheet or framework silicates.

Suitable oxidic raw materials, in particular metal oxides, for example include aluminas, aluminium oxide hydroxide (boehmite), zirconium oxides, barium titanate, lead zirconate titanate, ferrites, titanium dioxide and zinc oxide. Suitable boehmite compounds are described for example in WO 99/33125.

Suitable non-oxidic and non-metallic raw materials for example include silicon carbide, silicon nitride, aluminium nitride, boron nitride, titanium boride and molybdenum silicide.

The particles used in accordance with the invention consist of electrically insulating materials, preferably a non-electrically conducting oxide of the metals Al, Zr, Si, Sn, Ti and/or Y. The production of such particles is described in detail in DE-OA-10208277, for example.

Among the inorganic, preferably ceramic particles, particles based on oxides of silicon with the molecular formula SiO₂, and also mixed oxides with the molecular formula AlNaSiO₂, and oxides of titanium with the molecular formula TiO₂ are particularly preferred, wherein these can be present in crystalline, amorphous or mixed form. The inorganic, preferably ceramic particles are preferably polycrystalline materials, in particular those of which the crystallinity is more than 30%.

The inorganic, preferably ceramic coating according to the invention preferably has a thickness of from 0.1 μm to 50 μm, in particular 0.5 μm to 20 μm.

The application quantity of inorganic, preferably ceramic coating is preferably 0.3 g/m² to 60 g/m², in particular 0.5 g/m² to 40 g/m², in relation to binder plus particles after drying.

The application quantity of inorganic, preferably ceramic particles is preferably 0.2 g/m² to 40 g/m², in particular 0.25 g/m² to 30 g/m², in relation to particles after drying.

The inorganic, preferably ceramic coating according to the invention comprises inorganic, preferably ceramic particles that preferably have a density in the range from 1.5 to 10 g/cm³, preferably 2 to 8 g/cm³.

The inorganic, preferably ceramic coating according to the invention comprises inorganic, preferably ceramic particles that preferably have a hardness of at least 2 on the Mohs scale.

The inorganic, preferably ceramic coating according to the invention comprises inorganic, preferably ceramic particles that preferably have a melting point of at least 200° C., in particular at least 250° C., very particularly preferably preferably at least 300° C. In addition, the aforementioned particles also should not experience any decomposition at the specified temperatures. The aforementioned specifications can be determined by means of known methods, for example DSC (differential scanning calorimetry) or TG (thermogravimetry).

The inorganic, preferably ceramic coating according to the invention comprises inorganic, preferably ceramic particles that preferably have a compressive strength of at least 100 kPa, particularly preferably of at least 150 kPa, in particular of at least 250 kPa. Compressive strength means that at least 90% of the particles present have not been destroyed by the effective pressure.

Coatings that have a thickness from 0.1 μm to 50 μm and inorganic, preferably ceramic particles in the range between 0.05 and 15 μm (d50 value), preferably in the range 0.1 to 10 μm (d50 value), are preferred.

Coatings that (i) have a thickness from 0.1 μm to 50 μm and (ii) contain ceramic particles in the range between 0.05 and 15 μm (d50 value), of which the compressive strength is at least 100 kPa, particularly preferably at least 150 kPa, in particular at least 250 kPa, are particularly preferred.

Coatings that (i) have a thickness from 0.1 μm to 50 μm and (ii) contain inorganic, preferably ceramic particles in the range between 0.05 and 15 μm (d50 value), preferably in the range 0.1 to 10 μm (d50 value), of which the compressive strength is at least 100 kPa, particularly preferably at least 150 kPa, in particular at least 250 kPa, and the D50 value is no greater than 50% of the thickness of the inorganic, preferably ceramic coating, preferably no greater than 33% of the thickness of the inorganic, preferably ceramic coating, in particular no greater than 25% of the thickness of the inorganic, preferably ceramic coating, are particularly preferred.

The inorganic, preferably ceramic coating according to the invention, besides the aforementioned inorganic, preferably ceramic particles, also comprises at least one end-consolidated binder selected from the group of binders based on polyvinylene dichloride (PVDC), polyacrylates, polymethacrylates, polyethylene imines, polyesters, polyamides, polyimides, polyurethanes, polycarbonates, silicate binders, grafted polyolefins, rubber-like binders (for example styrene-butadiene copolymers: SBR), polymers from the class of halogenated, preferably fluorinated polymers, for example PTFE or PVDC, and mixtures thereof.

The binders used in accordance with the invention should be electrically insulating, that is to say should not have any electrical conductivity. Electrically insulating or no electrical conductivity means that these properties can be present to a limited extent, but do not increase the values compared to the unlaminated film.

The application quantity of end-consolidated binder selected from the group of binders based on polyvinylene dichloride (PVDC), polyacrylates, polymethacrylates, polyethylene imines, polyesters, polyamides, polyimides, polyurethanes, polycarbonates, silicate binders, grafted polyolefins, polymers from the class of halogenated polymers, for example PTFE, and mixtures thereof is preferably 0.05 g/m² to 20 g/m², in particular 0.1 g/m² to 10 g/m³, (only binder, dried). Preferred ranges for binders based on polyvinylene dichloride (PVDC) are 0.05 g/m² to 20 g/m², preferably 0.1 g/m² to 10 g/m², (only binder, dried).

The inorganic, preferably ceramic coating according to the invention, in relation to binder and inorganic, preferably ceramic particles in the dried state, comprises 98% by weight to 50% by weight of inorganic, preferably ceramic particles and 2% by weight to 50% by weight of binder selected from the group of binders based on polyvinylene dichloride (PVDC), polyacrylates, polymethacrylates, polyethylene imines, polyesters, polyamides, polyimides, polyurethanes, polycarbonates, silicate binders, grafted polyolefins, polymers from the class of halogenated polymers, for example PTFE, and mixtures thereof, wherein, among the binders, end-consolidated binders based on polyvinylene dichloride (PVDC) are preferred. Furthermore, the ceramic coating according to the invention may also contain additives to a limited extent, which are necessary for the handling of the dispersion.

The inorganic, preferably ceramic coating according to the invention is applied by means of known techniques, for example by slotted nozzle coating, doctoring or spraying, onto the particle-containing surface of the porous film.

The inorganic, preferably ceramic coating is preferably applied as a dispersion. These dispersions are preferably present as aqueous dispersions and, besides the inorganic, preferably ceramic particles according to the invention, comprise at least one of the aforementioned binders, preferably binders based on polyvinylene dichloride (PVDC), water and optionally organic substances, which improve the dispersion stability or increase the wettability to give a porous BOPP film. The inorganic substances are volatile organic substances, such as monovalent or polyvalent alcohols, in particular those of which the boiling point does not exceed 140° C. Due to availability, isopropanol, propanol and ethanol are particularly preferred.

The application of the inorganic, preferably ceramic particles is described in detail in DE-A-10208277, for example.

Preferred dispersions comprise:
(i) 20% by weight to 90% by weight, particularly preferably 30% by weight to 80% by weight, of inorganic, preferably ceramic particles,
(ii) 1% by weight to 30% by weight, particularly preferably 1.5% by weight to 20% by weight, of binders selected from the group of binders based on polyvinylene dichloride (PVDC), rubber-like binders, polyacrylates, polymethacrylates, polyethylene imines, polyesters, polyamides, polyimides, polyurethanes, polycarbonates, silicate binders, grafted polyolefins, polymers from the class of halogenated polymers, for example PTFE, and mixtures thereof, wherein, among the binders, end-consolidated binders based on polyvinylene dichloride (PVDC) are preferred,
(iii) optionally 1% by weight to 30% by weight, particularly preferably 0.01% by weight to 0.5% by weight, of organic substances, which improve the dispersion stability or increase the wettability to a give porous BOPP film, in particular monovalent or polyvalent alcohols,
(iv) optionally 0.00001% by weight to 10% by weight, particularly preferably 0.001% by weight to 5% by weight, of further additives, such as dispersion stabilisers and/or antifoaming agents,
(v) water, such that the sum of all components amounts to 100% by weight.

The films according to the invention formed of a particle-containing base film which is additionally provided with an inorganic coating are characterised by an excellent protective function. When used as a separator in batteries, the risk of fires and explosions can be considerably reduced. At very high temperature loads of more than 160° C., the particles of the porous film, also in conjunction with the particles of the inorganic coating, form an extremely effective and stable layer and reliably prevent electrode contact.

At the same time, following the coating of the base film, good gas permeabilities and low Gurley values are also maintained, such that the coated porous films according to the invention also satisfy all of the requirements of high-quality separator films.

The film can therefore be used advantageously in all applications in which a very high permeability and safeguarding against short circuits by electrode contact are required. The film according to the invention is therefore outstandingly suitable for use as a highly porous separator in batteries, in particular in lithium batteries with a high demand of power and safety.

In order to characterise the raw materials and the films, the following measurement methods were used:

Particle Size:

The mean particle size was determined by a laser light scattering method in accordance with ISO 13320-1. A suitable measuring apparatus for analysis is for example a Microtrac S 3500.

The size of the agglomerates and the absolute particle size of the individual particles (particles) can be examined by means of scanning electron microscope. For this purpose, either an SEM image of the particles, which have been spread on a sample carrier, is taken, or an SEM image of a film sample, coated with platinum or gold by thermal vapour deposition, of the uncoated porous film having a size of 10 mm², or SEM images of the granular material of the masterbatch. The uncoated film sample or the other corresponding images of the particles or of the batch are examined optically for the presence of particles having a size of more than 1 μm. The requirements of the porous film according to the invention are met if no more than one particle having an absolute size of >1 μm can be found in the SEM image of the uncoated film pattern of 10 mm².

Melt Flow Index

The melt flow index of the propylene polymers was measured in accordance with DIN 53 735 at 2.16 kg load and 230° C.

Melting Point

In the context of the present invention, the melting point is the maximum of the DSC curve. In order to determine the melting point, a DSC curve with a heating and cooling rate of 10 K/1 min in the range from 20 to 200° C. was recorded. In order to determine the melting point, the second heating curve was evaluated once cooled at 10 K/1 min in the range from 200 to 20° C., as is usual.

β-Content

The proportion of the β-crystalline polypropylene was determined by means of DSC. This characterisation is described in J. o. Appl. Polymer Science, Vol. 74, p.: 2357-2368, 1999 by Varga and is performed as follows: the sample doped with β-nucleator is first heated in the DSC at a heating rate of 20° C./min to 220° C. and is melted (1^{st} heating). Next, it is cooled at a cooling rate of 10° C./min to 100° C., before it is heated again at a heating rate of 10K/min (2^{nd} heating).

From the DSC curve of the first heating, the degree of crystallinity K_{β,DSC} (proportion of β-crystalline polypropylene) that is present in the measured sample (undrawn film, injection moulded part) is determined from the ratio of the enthalpies of fusion of the β-crystalline phase (H_{β}) to the sum of the enthalpies of fusion of β-crystalline and crystalline phase (H_{β}+H). The percentage value is calculated as follows:

K_{β,DSC}[%]=100×(H_{β})/(H_{β}+H)

From the DSC curve of the second heating, the degree of crystallinity K_{βDSC} (2^{nd} heating) that specifies the β-proportion of the particular polypropylene sample that can be achieved at most is determined from the ratio of the enthalpies of fusion of the 0-crystalline phase (Hp) to the sum of the enthalpies of fusion of 0-crystalline and crystalline phase (H_{β}+H).

Density

The density was determined in accordance with DIN 53 479, method A.

Maximum and Mean Pore Size

The maximum and the mean pore size were measured by means of the bubble point method according to ASTM F316.

Porosity

The density reduction (ρfilm-ρpp) of the film compared with the density of the pure polypropylene ppp is calculated as porosity as follows:

porosity[%]=100×(ρpp−ρfilm)/ρpp

Permeability/Penetrability (Gurley Value)

The permeability of the films was measured using the Gurley Tester 4110 in accordance with ASTM 726-58. Here, the time (in sec) required by 100 cm³ of air to permeate through the film surface of 1 inch² (6.452 cm²) was determined. The pressure difference over the film corresponds here to the pressure of a water column of 12.4 cm height. The required time then corresponds to the Gurley value, i.e. the unit is sec/100 cm³.

Adhesive Behaviour:

A laminated film sample measuring 6 cm×6 cm was cut out using a template. This piece was placed with 3 cm overlap on a stainless steel cube with edge radius: 0.5 mm of size 8×8×8 cm with 3 cm overlap. The protruding 3 cm were then bent at right angles over the cube edge. With poor adhesion of the coating, the coating flakes from the edge and can be rubbed off using the fingers.

With good adhesion, there is at most a crack at the bend edge, however the adhesion on the film remains intact.

Weight Per Unit Area

A defined film sample with an area of 100 mm×100 mm is cut out and then weighed on a set of analysis scales. This weight multiplied by 100 then gives the weight per unit area of a square metre of separator film in g/m².

Application Weight:

When determining the weight per unit area, the weight per unit area of the film is first noted before the coating and then after the coating. The difference between the two weights per unit area then gives the application weight of the inorganic coating in g/m².

The invention will now be explained by the following examples.

### EXAMPLES

### Example A: Batch Production

In a first step, a batch was produced from polymer (polypropylene) and particles and was used in the following test. This batch was produced as follows:

Approximately 60% by weight of a TiO2 pigment (Huntsmann TR28) together with 0.04% by weight of calcium pimelate as nucleating agent (calcium pimelate) were mixed, melted and granulated in a twin-screw extruder at a temperature of 230° C. and a screw revolution rate of 270 rpm with 39.96% by weight of granular material formed from isotactic polypropylene homopolymer (melting point 162° C.; MFI 3 g/10 min). The SEM images of the batch show finely distributed TiO2 particles with a particle size of from 20 to 500 nm without agglomerates of larger than 1 μm, The β-activity of the batch shows a value of 91% with the second heating.

### Example B: Film Production

### Film example: 1

After the extrusion method, a two-layer preliminary film was extruded from a flat film die at an extrusion temperature of 240 to 250° C. Here, the throughputs of the extruder were selected such that the thickness ratio of the layers A:B was 1:2. The multi-layer preliminary film was first removed on a chilling roll and cooled. The multi-layer preliminary film was then oriented and ultimately fixed in the longitudinal and transverse direction. The layers of the film had the following composition:

Composition of Layer A:

40% by weight TiO2 batch according to example A formed of

| | |
|---|---|
| 60% by weight | TiO2 |
| approx. 39.96% by weight | propylene homopolymer |
| 0.04% by weight | nucleating agent |

in each case based on the batch

60% by weight polypropylene mixture formed of:
approx. 60% by weight of propylene homopolymer (PP) with an n-heptane-soluble proportion of 4.5% by weight (based on 100% PP) and a melting point of 165° C.; and a melt flow index of 3.2 g/10 min at 230° C. and 2.16 kg load (DIN 53 735) and
approx. 39.96% by weight of propylene ethylene block copolymer with an ethylene proportion of approx. 5% by weight based on the block copolymer and a melt flow index (230° C. and 2.16 kg) of 6 g/10 min
0.04% by weight nano Ca pimelate as β-nucleating agent in each case based on the mixture

Composition of Layer B:

approx. 80% by weight propylene homopolymer (PP) with an n-heptane-soluble proportion of 4.5% by weight (based on 100% PP) and a melting point of 165° C.; and a melt flow index of 3.2 g/10 min at 230° C. and 2.16 kg load (DIN 53 735) and
approx. 19.96% by weight of propylene ethylene block copolymer with an ethylene proportion of approx. 5% by weight based on the block copolymer and a melt flow index (230° C. and 2.16 kg) of 6 g/10 min
0.04% by weight nano Ca pimelate as β-nucleating agent

The layers of the film additionally contained stabiliser and neutralising agent in conventional amounts. The nano Ca pimelate was produced as described in examples 1a or 1b of WO2011047797.

The polymer mixture was drawn after extrusion over a first take-off roll and a further roll trio, cooled and solidified, then longitudinally drawn, transversely drawn and fixed, wherein the following conditions were selected in particular:
extrusion: extrusion temperature 245° C.
chilling roll: temperature 125° C.,
discharge speed: 1.5 m/min (dwell time on the take-off roll: 55 sec)
longitudinal extension: preheating roll: 92 drawing roll T=90° C.
longitudinal drawing by the factor of 3.6
transverse drawing: heating field T=145° C.
drawing field T=145° C.
transverse drawing by the factor of 4.8
convergence: 13%

A roll of 1500 m continuous length was produced without tears. The porous film thus produced was approximately 30 μm thick and had a density of 0.33 g/cm³ and had a uniform white-opaque appearance. The porosity was 665% and the Gurley value 160 s. SEM images of the surface of side A showed no TiO2 agglomerates and no particles with a particle size >1 μm on an examined area of 10 mm².

### Film Example 2

A two-layer film as described in film example 1 was produced. In contrast to film example 1, the discharge speed was increased to 2.5 m/min. The composition of the layers and the other method conditions remained the same. In spite of the increased discharge speed, 800 m of continuous length were produced without tears. Here, the thickness reduced to 20 μm. In spite of the shorter dwell time on the take-off roll, the Gurley value reduced surprisingly to approximately 140 seconds. In this film as well, no TiO2 agglomerates were identified on the side A by means of SEM, and no particles with a particle size >1 μm were identified over an area of 10 mm².

### Film Example 3

A film as described in film example 1 was produced. In contrast to film example 1, the layer B now had the same composition as layer A. The composition of layer A and the method conditions remained the same. A single-layer film was thus produced. The thickness of the film was 31 μm and the Gurley value reduced surprisingly to less than 100 seconds. This composition as well demonstrated very good fault-free extent, and a roll of 2000 m continuous length was thus produced. Neither side of the film showed any TiO2 agglomerates by means of SEM, and no particles with a particle size >1 μm were identified over an area of 10 mm².

### Film Example 4

A single-layer film as described in film example 3 with 24% by weight of TiO2 was produced. The discharge speed was (as in film example 2) increased to 2.5 m/min. The (same) composition of layers A and B and the other method conditions remained the same. With the increased discharge speed of 2.5 m/min, a roll of 1000 m continuous length without tears was produced. Here, the thickness reduced to 20 μm and the Gurley value remained, as in example 3, surprisingly less than 100 seconds. In this film no agglomerates were identified on either side by means of SEM, and no particles with a particle size >1 μm were identified over an area of 10 mm².

### Film Example 5

A film as described in film example 3 with 24% by weight of TiO2 was produced. In contrast to film example 3, the polypropylene mixture now contained no nucleating agent and thus had the following composition:

approx. 60% by weight propylene homopolymer (PP) with an n-heptane-soluble proportion of 4.5% by weight (based on 100% PP) and a melting point of 165° C.; and a melt flow index of 3.2 g/10 min at 230° C. and 2.16 kg load (DIN 53 735) and
approx. 40% by weight propylene ethylene block copolymer with an ethylene proportion of approx. 5% by weight based on the block copolymer and a melt flow index (230° C. and 2.16 kg) of 6 g/10 min

Otherwise, the composition of the layer and the composition of the TiO2 batch and the method conditions were not changed compared to example 3.

Here as well, a roll of 1000 m continuous length without tears could be produced. The thickness of the film was 28 μm. Here, the Gurley value remained, as in film example 3, surprisingly less than 100 seconds. In this film as well, no agglomerates were identified in either layer by means of SEM, and no particles with a particle size >1 μm were identified over an area of 10 mm².

### Film Example 6

A two-layer film as described in film example 1 was produced. In contrast to film example 1 the concentration of the TiO2 batch in layer A was increased to 60% and the proportion of the polypropylene mixture was reduced to 40%, such that 36% by weight of TiO2 was present in the layer A. The composition of layer B and the method conditions remained the same. This composition as well demonstrated very good fault-free extent, and a roll of 1000 m continuous length was produced. The thickness of the film was 27 μm and the Gurley value reduced surprisingly to less than 100 seconds. Side A of the film did not reveal, by SEM, any agglomerates >1 μm over an area of 10 mm². However, one particle with a particle size of approx. 1.2 μm was identified.

### Film Example 7

A two-layer film was produced under the same conditions and with the same formulation as film example 2. However, the discharge speed was increased to 5 m/min and therefore the end film speed was increased to 19 m/min. In order to ensure production of a film of constant thickness under these conditions, the extrusion throughput was additionally doubled. This composition also demonstrated a very good fault-free extent at the higher process speed, and a roll with 1000 m continuous length was produced. The thickness of the film was 27 μm and the Gurley value increased compared to example 2 to 170 seconds, wherein the β-content measured on the preliminary film reduced slightly to 57%. Side A of the film did not reveal any agglomerates in SEM, and no particles with a particle size >1 μm were identified over an area of 10 mm².

### Film Example 8

A two-layer film was produced under the same conditions and with the same formulation as film example 2. However, the discharge speed was increased to 7.5 m/min and therefore the end film speed was increased to 28 m/min. In order to ensure production of a film of constant thickness under these conditions, the extrusion throughput was additionally doubled. This composition also demonstrated a very good fault-free extent at the higher process speed, and a roll with 1000 m continuous length was produced. The thickness of the film was 24 μm and the Gurley value increased compared to example 7 to 198 seconds, wherein the 3-content measured on the preliminary film reduced slightly to 54%. Side A of the film did not reveal any agglomerates in SEM, and no particles with a particle size >1 μm were identified over an area of 10 mm².

### Film Example 9

A two-layer film was produced under the same conditions and with the same formulation as film example 2 was produced. However, the discharge speed was increased to 10 m/min and therefore the end film speed was increased to 37 m/min. In order to ensure production of a film of constant thickness under these conditions, the extrusion throughput was additionally doubled. This composition also demonstrated a very good fault-free extent at the higher process speed, and a roll with 1000 m continuous length was produced. The thickness of the film was 24 μm and the Gurley value increased compared to example 8 to 222 seconds, wherein the β-content measured on the preliminary film reduced slightly to 51%. Side A of the film did not reveal any agglomerates in SEM, and no particles with a particle size >1 μm were identified over an area of 10 mm².

### Film Example 10

A two-layer film was produced under the same conditions as film example 2. However, in layer A and layer B the propylene-ethylene block copolymer was replaced by an increase of the proportion of the propylene homopolymer (PP).

This composition also demonstrated a very good fault-free extent in spite of the absence of the block copolymer, and a roll with 1000 m continuous length was produced. The thickness of the film was 27 μm and the Gurley value was 170 seconds. This composition also demonstrated very good fault-free extent, and a roll of 1000 m continuous length was produced. Side A of the film did not reveal any agglomerates in SEM, and no particles with a particle size >1 μm were identified over an area of 10 mm².

### Comparative Example 1

A film was produced under the same conditions as described in film example 1. In contrast to film example 1, the same mixture as for layer B was used for layer A and therefore the addition of TiO2 was omitted. The composition of layer B and also the method conditions remained the same. A single-layer film was thus produced. The thickness of the film was 29 μm and the Gurley value was 200 seconds.

### Comparative Example 2

A film was produced under the same conditions as described in comparative example 1. In contrast to comparative example 1, the discharge speed was increased here to 2.5 m/min. With the increased discharge speed 500 m of continuous length without tears were produced. Here, the thickness reduced to 20 μm and the Gurley value increased to 280 seconds.

### Comparative Example 3

A two-layer film was produced under the same conditions as described for film example 1. In contrast to film example 1, the composition of the batch of layer A was changed. The TiO2 was replaced by an Al2O3 with a mean particle diameter of 3 μm. The composition of the polypropylene mixture of layer A, the composition of layer B, and the method conditions remained the same. However, it was not possible to produce a film on account of numerous tears.

### Comparative Example 4

A two-layer film was produced under the same conditions as described for film example 1. However, the TiO2 instead of a batch was incorporated into the extruder by direct metered addition. Tears were encountered frequently during the production process. The few films produced in principle demonstrated the same properties as the films according to example 1. Side A of the film showed a number of agglomerates in SEM with a size of from 1 to 3 μm over an area of 10 mm².

TABLE 1

| | | CE1 | CE2 | Ex. 1 | Ex. 2 | Ex. 3 | Ex. 4 | Ex. 5 | Ex. 6 |
|---|---|---|---|---|---|---|---|---|---|
| Particle material | | / | / | TiO2 | TiO2 | TiO2 | TiO2 | TiO2 | TiO2 |
| Mean particle | nm | | | 200 | 200 | 200 | 200 | 200 | 200 |
| size | | | | | | | | | |
| Particle shape | | | | spherical | spherical | spherical | spherical | spherical | spherical |
| Nucleator conc. | % | 0.04 | 0.04 | 0.04 | 0.04 | 0.04 | 0.04 | 0 | 0.04 |
| Film structure | | single- | single- | two-layer | two-layer | single- | single- | single- | two-layer |
| | | layer | layer | A/B | A/B | layer | layer | layer | A/B |
| TiO2 conc. | % by | 0 | 24 | 24 | 24 | 24 | 24 | 24 | 36 |
| in layer A | weight | | | | | | | | |
| Ratio A/B | | | | 1:2 | 1:2 | | | | 1:2 |
| Length in metres | m | 500 | 500 | 1600 | 800 | 2000 | 1000 | 1000 | 800 |
| without tears | | | | | | | | | |
| Discharge speed | m/min | 1.5 | 2.5 | 1.5 | 2.5 | 1.5 | 2.5 | 1.5 | 1.5 |
| Particles with a | | | | 0 | 0 | 0 | 0 | 0 | 1 |
| size >1 μm | | | | | | | | | |
| over 10 mm² | | | | | | | | | |
| Process speed | m/min | 5.92 | 9.25 | 5.92 | 9.25 | 5.92 | 9.25 | 5.92 | 5.92 |
| Thickness | μm | 29 | 20 | 30 | 20 | 31 | 20 | 28 | 27 |
| Density | Kg/m³ | 0.32 | 0.33 | 0.34 | 0.35 | 0.35 | 0.37 | 0.37 | 0.33 |
| Porosity | % | 60.5 | 59.5 | 58.5 | 57.5 | 57.5 | 55.5 | 55.5 | 59.5 |
| Maximum pore | nm | 65 | 63 | 79 | 76 | 146 | 152 | 146 | 84 |
| size | | | | | | | | | |
| Mean pore size | nm | 57 | 54 | 58 | 57 | 119 | 109 | 112 | 67 |
| Gurley | s/100 cm³ | 199 | 280 | 160 | 138 | 91 | 98.9 | 99.9 | 144 |
| β-content | % | 66 | 64 | 63 | 64 | 66 | 62 | 61 | 66 |
| preliminary | | | | | | | | | |
| film | | | | | | | | | |

| | | Ex. 7 | Ex. 8 | Ex. 9 | Ex. 10 |
|---|---|---|---|---|---|
| Particle material | | TiO2 | TiO2 | TiO2 | TiO2 |
| Mean particle | nm | 200 | 200 | 200 | 200 |
| size | | | | | |
| Particle shape | | spherical | spherical | spherical | spherical |
| Nucleator conc. | % | 0.04 | 0.04 | 0.04 | 0.04 |
| Film structure | | two-layer | two-layer | two-layer | two-layer |
| | | A/B | A/B | A/B | A/B |
| TiO2 conc. | % by | 24 | 24 | 24 | 24 |
| in layer A | weight | | | | |
| Ratio A/B | | 1:2 | 1:2 | 1:2 | 1:21:2 |
| Length in metres | m | 1000 | 1000 | 1000 | 1000 |
| without tears | | | | | |
| Discharge speed | m/min | 5 | 7.5 | 10 | 2.5 |
| Particles with a | | 0 | 0 | 0 | 0 |
| size >1 μm | | | | | |
| over 10 mm² | | | | | |
| Process speed | m/min | 18.5 | 27.75 | 37.00 | 9.25 |
| Thickness | μm | 27 | 24 | 21 | 30 |
| Density | Kg/m³ | 0.37 | 0.39 | 0.41 | 0.34 |
| Porosity | % | 55.5 | 53.5 | 51.5 | 58.5 |
| Maximum pore | nm | 64 | 66 | 69 | 76 |
| size | | | | | |
| Mean pore size | nm | 56 | 57 | 57 | 57 |
| Gurley | s/100 cm³ | 55 | 53 | 50 | 72 |
| β-content | % | 170 | 196 | 222 | 170 |
| preliminary | | | | | |
| film | | | | | |

Production of the Dispersions:

Binder-Particle Dispersion 1:

1 g of nanoscale TiO2 (Aeroxide TiO2 P25 from Evonik) was first dispersed in 9 g of water to obtain an aqueous 10% by weight particle-containing aqueous dispersion. 5 g of a binder dispersion were then added to this particle dispersion. The two dispersions were mixed with one another by stirring. The binder dispersion was an aqueous acrylate dispersion with an acrylate proportion of 20% by weight (Neocryl FL-715 in H2O from DSM Neoresins). 15 g of the binder-particle dispersion were then added to and mixed with 1.5 g isopropanol for improved wetting of the separator. In this way, 16.5 g of the finished particle-binder dispersion were obtained for the coating.

Binder-Particle Dispersion 2:

A dispersion as described in dispersion example 1 was produced. In contrast to dispersion example 1, 2 g of nanoscale TiO2 (Aeroxide TiO2 P25 from Evonik) were dispersed in 8 g of water to obtain an aqueous 20% by weight particle-containing dispersion. 5 g of the aqueous acrylate dispersion (Neocryl FL-715 in H2O from DSM Neoresins with an acrylate proportion of 20% by weight) were then added to and stirred together with this particle dispersion. Another 15 g of the binder-particle dispersion were then mixed with 1.5 g isopropanol. In this way, 16.5 g of the finished particle-binder dispersion were obtained for the coating.

Binder-Particle Dispersion 3:

A dispersion as described in dispersion example 1 was produced. In contrast to dispersion example 1, 3 g of nanoscale TiO2 (Aeroxide TiO2 P25 from Evonik) were dispersed in 7 g of water to obtain an aqueous 30% by weight particle-containing dispersion. 5 g of the aqueous acrylate dispersion (Neocryl FL-715 in H2O from DSM Neoresins with an acrylate proportion of 20% by weight) were then added to and stirred together with this particle dispersion. Another 15 g of the binder-particle dispersion were then mixed with 1.5 g isopropanol. In this way, 16.5 g of the finished particle-binder dispersion were obtained for the coating.

Binder-Particle Dispersion 4:

1 g of Al2O3 particles (AKP-3000 from Sumimoto, D50 value: 0.66 μm) was first dispersed in 9 g of water to obtain an aqueous 10% by weight particle-containing dispersion. 2 g of a binder dispersion were then added to this particle dispersion and the mixture was stirred. The binder dispersion was an aqueous acrylate dispersion with an acrylate proportion of 20% by weight (Neocryl FL-715 in H2O from DSM Neoresins). 12 g of the binder-particle dispersion were then added to and mixed with 1.5 g isopropanol. In this way, 13.5 g of the finished dispersion were obtained.

Binder-Particle Dispersion 5:

A dispersion as described in dispersion example 4 was produced. In contrast to dispersion example 4, 2 g of sub-μm Al2O3 particles (AKP-3000 from Sumimoto, D50 value: 0.66 μm) were dispersed in 8 g of water to obtain an aqueous 20% by weight particle-containing dispersion. 2 g of the aqueous acrylate dispersion (acrylate proportion of 20% by weight Neocryl FL-715 in H2O from DSM Neoresins) were then added to and stirred together with this particle dispersion. 12 g of the binder-particle dispersion were then mixed with 1.5 g isopropanol. In this way, 13.5 g of the finished particle-binder dispersion were obtained.

Binder-Particle Dispersion 6:

1 g of boehmite (A12020H) particles (Dispersal 40 from Sasol. D50: ˜350 nm) was first dispersed in 9 g of water to obtain an aqueous 10% by weight particle-containing dispersion. 2 g of the aqueous acrylate dispersion (acrylate proportion of 20% by weight Neocryl FL-715 in H2O from DSM Neoresins) were then added to and mixed with this particle dispersion. 12 g of the binder-particle dispersion were then mixed with 1.5 g isopropanol. In this way, 13.5 g of the finished particle-binder dispersion were obtained.

Binder-Particle Dispersion 7:

A dispersion as described in dispersion example 4 was produced. In contrast to dispersion example 4, 2 g of boehmite particles (Dispersal 40 from Sasol. D50: ˜350 nm) were dispersed in 8 g of water to obtain an aqueous 20% by weight particle-containing dispersion. 2 g of the aqueous acrylate dispersion (acrylate proportion of 20% by weight Neocryl FL-715 in H2O from DSM Neoresins) were then added to and stirred together with this particle dispersion. 12 g of the binder-particle dispersion were then mixed with 1.5 g isopropanol. In this way, 13.5 g of the finished particle-binder dispersion were obtained.

Production of Coated Films:

Table 2:

For the described coating examples 1 to 7 described hereinafter, the film according to film example 4 was coated with the binder-particle dispersions 1 to 7. The results are summarised in Table 2.

### Coating Example 1

Samples of DIN A4 size were cut from the particle-containing film from film example 4 and fixed on a glass plate. The dispersion (approx. 5 to 10 g) from dispersion example 1 was then applied to the surface of the particle-containing film using a hand-held doctor blade. The film was then dried for 5 min at 70° C. in a drying cabinet and was then examined in respect of its properties. After drying, a coating weight of approx. 2 g/m² was determined for the ceramic coating by means of weighing. The thickness of the separator increased after coating from 20 μm to 22 μm. The Gurley value increased from 98 to 165 s. The coating demonstrated excellent adhesion in the Tesa test.

### Coating Example 2

The dispersion 2 was applied to the surface of the particle-containing film using a hand-held doctor blade as described in coating example 1. The film was then dried for 5 min at 70° C. in a drying cabinet. After the drying, a coating weight of approx. 2 g/m² was determined for the ceramic coating. The thickness of the separator increased after coating from 20 μm to 22.5 μm. The Gurley value increased from 98 to 142 s. The coating demonstrated very good adhesion in the Tesa test.

### Coating Example 3

The dispersion 3 was applied to the surface of the particle-containing film using a hand-held doctor blade as described in coating example 1. The film was then dried for 5 min at 70° C. in a drying cabinet. After the drying, a coating weight of approx. 2 g/m² was determined for the ceramic coating. The thickness of the separator increased after coating from 20 μm to 22 μm. The Gurley value increased from 98 to 123 s. The coating demonstrated very good adhesion in the Tesa test.

### Coating Example 4

The dispersion 4 was applied to the surface of the particle-containing film using a hand-held doctor blade as described in coating example 1. The film was then dried for 5 min at 70° C. in a drying cabinet before it was examined. After the drying, a coating weight of approx. 2.5 g/m² was determined for the ceramic coating. The thickness of the separator increased after coating from 20 μm to 22.5 μm. The Gurley value increased from 98 to 159 s. The coating demonstrated excellent adhesion in the Tesa test.

### Coating Example 5

The dispersion 5 was applied to the surface of the particle-containing film using a hand-held doctor blade as described in coating example 1. The film was then dried for 5 min at 70° C. in a drying cabinet before it was examined further. After the drying, a coating weight of approx. 2.5 g/m² was determined for the ceramic coating. The thickness of the separator increased after coating from 20 μm to 23 μm. The Gurley value increased from 98 to 138 s. The coating demonstrated good adhesion in the Tesa test.

### Coating Example 6

The dispersion 6 was applied to the surface of the particle-containing film using a hand-held doctor blade as described in coating example 1. The film was then dried for 5 min at 70° C. in a drying cabinet before it was examined further. After the drying, a coating weight of approx. 2.5 g/m² was determined for the ceramic coating. The thickness of the separator increased after coating from 20 μm to 23 μm. The Gurley value increased from 98 to 144 s. The coating demonstrated very good adhesion in the Tesa test.

### Coating Example 7

The dispersion 7 was applied to the surface of the particle-containing film using a hand-held doctor blade as described in coating example 1. The film was then dried for 5 min at 70° C. in a drying cabinet before it was examined further. After the drying, a coating weight of approx. 2.5 g/m² was determined for the ceramic coating. The thickness of the separator increased after coating from 20 μm to 22.5 μm. The Gurley value increased from 98 to 128 s. The coating demonstrated good adhesion in the Tesa test.

TABLE 2

| | Binder-particle dispersions 1 to 7 on film example 4 | | | | | | |
|---|---|---|---|---|---|---|---|
| | Coating | Coating | Coating | Coating | Coating | Coating | Coating |
| | example | example | example | example | example | example | example |
| | 1 | 2 | 3 | 4 | 5 | 6 | 7 |
| Binder | Acrylate Neocryl FL-175 in H2O (DSM neoresins) | | | | | | |
| Initial weight of binder disp. [g] | 5 | 5 | 5 | 2 | 2 | 2 | 2 |
| Proportion of binder in binder disp. [%] | 20 | 20 | 20 | 20 | 20 | 20 | 20 |
| Ceramic | Aeroxide TiO2 P25 in H2O | | | Sumimoto AKP 3000 | | Boehmite Dispersal 40 | |
| Initial weight of ceramic disp. [g] | 10 | 10 | 10 | 10 | 10 | 10 | 10 |
| Proportion of ceramic in ceramic disp. [%] | 10 | 20 | 30 | 10 | 20 | 10 | 20 |
| Wetting agent | Isopropanol | | | | | | |
| Initial weight of wetting agent [g] | 1.5 | 1.5 | 1.5 | 1.5 | 1.5 | 1.5 | 1.5 |
| Total dispersion [g] | 16.5 | 16.5 | 16.5 | 13.5 | 13.5 | 13.5 | 13.5 |
| % by weight acrylate in coating disp. | 6.06 | 6.06 | 6.06 | 2.96 | 2.96 | 2.96 | 2.96 |
| % by weight particles in coating disp. | 6.06 | 12.12 | 18.18 | 7.41 | 14.81 | 7.41 | 14.81 |
| Ceramic:binder ratio | 1:1 | 2:1 | 3:1 | ~72:28 | ~83:17 | ~72:28 | -83:17 |
| Weight per unit area [g/m²] | 10.8 | 11.08 | 10.88 | 10.52 | 11.68 | 11.56 | 11.6 |
| Coating weight [g/m²] | 2 | 2 | 2 | 2.5 | 2.5 | 2.5 | 2.5 |
| Thickness [μm] | 22 | 22.5 | 22 | 22.5 | 23 | 23 | 23 |
| Gurley [sec/100 cm³] | 165 | 142 | 123 | 159 | 138 | 144 | 128 |
| Adhesion | good | good | good | good | good | good | good |

Table 3

For comparative examples 1 to 7 (Table 3), the film according to film comparative example 2 was coated with the binder-particle dispersions 1 to 7. The results are summarised in Table 3.

Film comparative example 2 with dispersions 1 to 7: Seven samples of DIN A4 size were cut from the film according to film comparative example 2 and fixed on a glass plate. 5 to 10 g of each of the dispersions from dispersion examples 1 to 7 were then applied to the surface of the film according to comparative example 2 using a hand-held doctor blade. The films thus coated were then dried for 5 min at 70° C. in a drying cabinet and then examined in respect of their properties. The coating weight after drying, the thickness and the Gurley value and the adhesion of the coated film were examined. The results are summarised in Table 3.

TABLE 3

| | Dispersion examples 1 to 7 on film according to comparative example 2 | | | | | | |
|---|---|---|---|---|---|---|---|
| | Coating | Coating | Coating | Coating | Coating | Coating | Coating |
| | example | example | example | example | example | example | example |
| | 1 | 2 | 3 | 4 | 5 | 6 | 7 |
| Binder | Acrylate Neocryl FL-175 in H2O (DSM neoresins) | | | | | | |
| Initial weight of binder disp. [g] | 5 | 5 | 5 | 2 | 2 | 2 | 2 |
| Proportion of binder in binder disp. [%] | 20 | 20 | 20 | 20 | 20 | 20 | 20 |
| Ceramic | Aeroxide TiO2 P25 in H2O | | | Sumimoto AKP 3000 | | Boehmite Dispersal 40 | |
| Initial weight of ceramic disp. [g] | 10 | 10 | 10 | 10 | 10 | 10 | 10 |
| Proportion of ceramic in ceramic disp. [%] | 10 | 20 | 30 | 10 | 20 | 10 | 20 |
| Wetting agent | Isopropanol | | | | | | |
| Initial weight of wetting agent [g] | 1.5 | 1.5 | 1.5 | 1.5 | 1.5 | 1.5 | 1.5 |
| Total dispersion [g] | 16.5 | 16.5 | 16.5 | 13.5 | 13.5 | 13.5 | 13.5 |
| % by weight acrylate in coating disp. | 6.06 | 6.06 | 6.06 | 2.96 | 2.96 | 2.96 | 2.96 |
| % by weight particles in coating disp. | 6.06 | 12.12 | 18.18 | 7.41 | 14.81 | 7.41 | 14.81 |
| Ceramic:binder ratio | 1:1 | 2:1 | 3:1 | ~72:28 | ~83:17 | ~72:28 | ~83:17 |
| Weight per unit area [g/m²] | 10.8 | 11.08 | 10.88 | 10.52 | 11.68 | 11.56 | 11.6 |
| Coating weight [g/m²] | 2 | 2 | 2 | 2.5 | 2.5 | 2.5 | 2.5 |
| Thickness [μm] | 22 | 22.5 | 22 | 22.5 | 23 | 23 | 23 |
| Gurley [sec/100 cm³] | 665 | 620 | 580 | 523 | 538 | 585 | 553 |
| Adhesion | poor | good | good | poor | good | good | good |

Table 4

For examples 1 to 10 of Table 4, the film according to film examples 1 to 10 was coated with the binder-particle dispersion 3. The results are summarised in Table 4.

Examples 1 to 10 with dispersion 3 on film examples 1 to 10: Samples of DIN A4 size were cut from the films according to film examples 1 to 10 and fixed on a glass plate. The dispersion according to dispersion example 3 was then applied to the surface of these film samples 1 to 10 using a hand-held doctor blade. In the case of the films according to film examples 1, 2 and 6 to 10, the surface of the particle-containing layer (layer A) was coated. The films thus coated were then dried for 5 min at 70° C. in a drying cabinet and then examined in respect of their properties. The coating weight after drying, the thickness and the Gurley value and the adhesion of the coated film were examined. The results are summarised in Table 4.

TABLE 4
Dispersion according to example 3: 20% acrylate binder + 30% TiO2
particles (acrylate Neocryl FL-715 DSM neoresins) in water with isopropanol

| | Dispersion example 3 on films according to examples 1 to 10 | | | | | | | | | |
|---|---|---|---|---|---|---|---|---|---|---|
| | Film | Film | Film | Film | Film | Film | Film | Film | Film | Film |
| | example | example | example | example | example | example | example | example | example | example |
| | 1 | 2 | 3 | 4 | 5 | 6 | 7 | 8 | 9 | 10 |
| Thickness [μm] | 30 | 20 | 31 | 20 | 28 | 27 | 27 | 24 | 21 | 30 |
| Density [kg/m³] | 0.34 | 0.35 | 0.35 | 0.37 | 0.37 | 0.33 | 0.37 | 0.39 | 0.41 | 0.34 |
| Porosity [%] | 58.5 | 57.5 | 57.5 | 55.5 | 55.5 | 59.5 | 55.5 | 53.5 | 51.5 | 58.5 |
| Maximum pore size [nm] | 79 | 76 | 146 | 152 | 146 | 84 | 64 | 66 | 69 | 76 |
| Mean pore size [nm] | 58 | 57 | 119 | 109 | 112 | 67 | 56 | 57 | 57 | 57 |
| Gurley [s/100 cm³] before coating | 160 | 138 | 91 | 98.9 | 99.9 | 144 | 170 | 196 | 222 | 170 |
| β-content preliminary film [%] | 63 | 64 | 66 | 62 | 61 | 66 | 55 | 53 | 50 | 72 |

Values after coating

| | | | | | | | | | | |
|---|---|---|---|---|---|---|---|---|---|---|
| Weight per unit area [g/m²] | 12.4 | 9.1 | 12.73 | 9.1 | 11.74 | 11.41 | 11.41 | 10.42 | 9.43 | 12.4 |
| Application weight [g/m²] | 2.5 | 2.5 | 2.5 | 2.5 | 2.5 | 2.5 | 2.5 | 2.5 | 2.5 | 2.5 |
| Thickness [μm] | 32 | 22 | 33 | 22 | 30 | 29 | 29 | 26 | 23 | 32 |
| Gurley of coated film [sec/100 cm³] | 195 | 188 | 146 | 123 | 144 | 144 | 260 | 296 | 310 | 224 |
| Adhesion | good | good | good | good | good | good | good | good | good | good |

1.-24. (canceled)

25. A biaxially oriented, single- or multi-layer porous film, containing a 3-nucleating agent and comprising at least one porous layer, which contains at least one propylene polymer and particles, said particles having a melting point of more than 200° C. and said porous film having, on the outer surface of the porous layer, a coating of inorganic.

26. The film according to claim 25, wherein the porosity of the film is produced by conversion of 3-crystalline polypropylene as the film is drawn.

27. The film according to claim 25, wherein the film contains 2 to 60% by weight of particles, in relation to the weight of the porous layer, and at most one particle having a particle size of >1 μm can be detected in an SEM image of an uncoated film sample of 10 mm².

28. The film according to claim 25, wherein no particles having a particle size of >1 m can be detected in an SEM image of an uncoated film sample of 10 mm².

29. The film according to claim 25, wherein the β-nucleating agent is contained in the porous, particle-containing layer of the film.

30. The film according to claim 25, wherein the porous, particle-containing layer of the film contains 50 to 85% by weight of propylene homopolymer, 15 to 50% by weight of propylene block copolymer, and 50 to 10,000 ppm of f-nucleating agent.

31. The film according to claim 25, wherein the coated film has a Gurley value of less than 500 s.

32. The film according to claim 25, wherein the particles of the porous layer are inorganic spherical particles.

33. The film according to claim 25, wherein the particles of the porous, particle-containing layer are not vacuole-initiating particles, wherein vacuole-initiating particles are particles which, under biaxial drawing of a polypropylene film without β-nucleating agent, lower the density of the polypropylene film to <0.85 g/cm³.

34. The film according to claim 25, wherein the particles of the porous, particle-containing layer are inorganic particles, are electrically non-conductive oxides of the metals Al, Zr, Si, Sn, Ti and/or Y.

35. The film according to claim 25, wherein the particles of the porous, particle-containing layer are TiO₂ particles.

36. The film according to claim 25, wherein the coating of inorganic particles are ceramic particles which comprises particles of which the particle size, expressed as D50 value, lies in the range between 0.05 and 15 μm.

37. The film according to claim 25, wherein the particle of the coating comprises an electrically non-conductive oxide of the metals Al, Zr, Si, Sn, Ti and/or Y.

38. The film according to claim 25, wherein the particles of the coating comprise particles based on oxides of silicon with the molecular formula SiO₂, and mixed oxides with the molecular formula AlNaSiO₂, and oxides of titanium with the molecular formula TiO₂, wherein these are present in crystalline, amorphous or mixed form.

39. The film according to claim 25, wherein the particles of the coating have a melting point of at least 200° C.

40. The film according to claim 25, wherein the particles of the coating are ceramic particles.

41. The film according to claim 40, wherein the ceramic coating has a thickness of from 0.5 μm to 80 μm.

42. The film according to claim 40, wherein the application amount of ceramic coating is 0.5 g/m² to 80 g/m².

43. The film according to claim 40, wherein the ceramic coating comprises ceramic particles, the compressive strength of which is at least 100 kPa.

44. The film according to claim 40, wherein the ceramic coating also contains at least one end-consolidated binder selected from the group of binders based on polyvinylene dichloride (PVDC), polyacrylates, polymethacrylates, polyethylene imines, polyesters, polyamides, polyimides, polyurethanes, polycarbonates, silicate binders, grafted polyolefins, polymers from the class of halogenated polymers, and mixtures thereof.

45. The film according to claim 40, wherein the ceramic coating also contains at least one end-consolidated binder based on polyvinylene dichloride (PVDC).

46. The film according to claim 40, wherein the ceramic coating contains 98% by weight to 50% by weight of ceramic particles and 2% by weight to 50% by weight of at least one end-consolidated binder selected from the group of binders based on polyvinylene dichloride (PVDC), polyacrylates, polymethacrylates, polyethylene imines, polyesters, polyamides, polyimides, polyurethanes, polycarbonates, silicate binders, grafted polyolefins, polymers from the class of halogenated polymers, and mixtures thereof.

47. Lithium, lithium-ion, lithium-polymer or alkaline earth batteries which comprise the film according to claim 25.

48. High-power or high-performance systems comprising the film according to claim 25.
